(19) United States
(12) Patent Application Publication
(10) Pub. No.: US 2010/0197516 A1
(43) Pub. Date: Aug. 5, 2010

(54) DETECHIP: MOLECULAR COLOR AND FLUORESCENT SENSORY ARRAYS FOR SMALL MOLECULES

(76) Inventor: Andrea Holmes, Crete, NE (US)

Correspondence Address: Attn. David J. Symonsbergen;Novel Chemical Solutions, Suite 1, 1155 Highway 33, Crete, NE, 68333, US

(21) Appl. No.: 12/503,260

(22) Filed: Jul. 15, 2009

Related U.S. Application Data
(60) Provisional application No. 61/080,711, filed on Jul. 15, 2008.

(51) Int. Cl. C40B 30/04; C40B 60/12; C40B 40/06

(52) U.S. Cl. 506/9; 506/39; 506/16

(57) ABSTRACT

A small molecule detection device including a chamber, a carrier within the chamber, and a dye in combination with the carrier is disclosed. The dye is capable of interacting with a small molecule target to produce a detectable change in color, fluorescence, mass uptake, refractive index, extinction coefficient, or solubility. A method of using the device is also disclosed.

### CROSS REFERENCE TO RELATED APPLICATION

This application is a non-provisional of U.S. Application Ser. No. 61/080,711 filed on Jul. 15, 2008, titled MOLECULAR COLOR AND FLUROESCENT SENSOR ARRAYS FOR SMALL MOLECULES which is incorporated by reference herein in its entirety.

### BACKGROUND OF THE INVENTION

This application relates to strategies that relate to the recognition and identification of small molecules, including but not limited to, abused narcotics, drugs, pesticides, steroids and their metabolites, poisons, toxins, chemical warfare agents, environmental poisons, explosives and the starting materials used to make them, as well as mixtures of small molecules:
1. Colored and/or fluorescent molecular sensors that could be used for quick-check field tests, clinical use, forensic, or personal use.
2. Development of a carrier such as a solid matrix, including but not limited to sol-gel, silicates, diatomaceous earth, cornstarch, talc, kaolin, and polymers like Nylon-12. These solids can carry the newly developed molecular sensors by absorption, adsorption, adhesion, covalent bonding, chelation, or encapsulation, to name a few, making the field tests user-friendly. These solids can be easily attached to any surface with glue. The carriers may be solid or liquid solutions.
3. Development of an assay referred to as “DETECHIP” that allows for the identification of unknown substances by the use of a binary code.

### SUMMARY

Some embodiments relate to a small molecule detection device including a chamber, a carrier within the chamber, and a dye in combination with the carrier. The dye is capable of interacting with a small molecule target to produce a detectable change in color, fluorescence, mass uptake, refractive index, extinction coefficient, or solubility.

### DETAILED DESCRIPTION

The current application is dedicated to novel, highly selective, and sensitive molecular sensors that change color in the presence of certain small molecules. By way of example, illegal narcotics are discussed extensively herein. In some embodiments, suitable oligonucleotide-based binders (aptamers), and other colored and/or fluorescent dyes are found that can be used as sensors for commonly abused drugs such as cocaine, Δ⁹-tetrahydrocannabinoldate (THC) from marijuana, date-rape and club drugs such as flunitrazepam or gamma-hydroxy butyric acid (GHB), and methamphetamine, to name a few. The most drug-specific aptamers and dyes are obtained by attachment of the drugs to resins, followed by exposure to a random selection of aptamer sequences. The binding sequences are enriched by repeating affinity chromatography. Organic dyes that form strong complexes with binding aptamers have been found using a combinatorial 96-well plate approach.

“Sol-gels” are based on solid colloidal silicates that will form a porous hard gel and is used to incorporate the aptamer-dye complexes, allowing for the attachment of the new molecular sensors to a solid base. This allows for potential use in forensic field tests or personal testing kits. Paper substrates, diatomaceous earth, talc, kaolin, or cornstarch also serve as carriers for the newly developed sensors.

“DETECHIP” is an assay that allows for the definitive identification of compounds while lessening the occurrence of false negatives or positives.

### A. Screening of Colorimetric Drug Sensors Using Aptamers

Current “club drugs” include ketamines, 4-hydroxybutanoic acid (GHB), ephedrine, methamphetamine, amphetamine, flunitrazepam, and

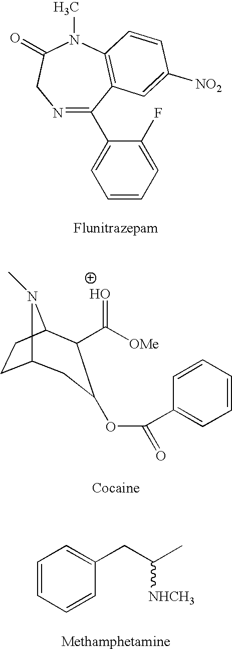

other benzodiazepines such as clonazepam, THC, and many more. Flunitrazepam (Rohypnol), for example, has never been commercialized in the United States but is illegally smuggled in for intent as a “date rape drug.” This compound is a dangerous and sometimes lethal drug that can be added into a drink when a person is not looking. Usually colorless and odorless, “roofies” causes incapacitation and memory loss. While unconscious, the victim may be raped, but cannot prove it afterward because the effects of the quickly metabolized drug last only four to six hours. Low levels of the drug's metabolites are challenging to detect, unless the victim explicitly requests a specific urinalysis to test for “roofies” in a timely manner. Due to the fact that flunitrazepam has been used in such a sinister context, the major pharmaceutical supplier of this drug, Hoffman La Roche, has added a blue dye to its drug. However, this compound is available on the black market in many areas of the former Soviet Union, South America, and Asia.

The simple “mix and measure” assays with very stable signaling oligonucleotide-aptamers allow for the development of highly selective and sensitive molecular sensors for many abused drugs, possibly leading to commercially available rapid screening reagents or “quick-check field tests” to be used either in forensic science, or in the case of flunitrazepam, to be used in personal “date rape prevention kits” by anyone who feels they may be a potential victim of sexual assault. Similar to flunitrazepam, these drugs bind to benzodiazepine receptors, and contain a pharmacophore with basic sites, a hydrophobic group, and an aromatic ring. Like GHB, flunitrazepam acts as an inhibitory neurotransmitter in the mammalian brain and is involved in inducing sedation and reduction of anxiety.

Current screening reagents for abused narcotics like flunitrazepam lack selectivity, and are sensitive to many tertiary amines such as methylephedrine, caffeine, nicotine, and others. Furthermore, these methods detect these drugs after consumption has occurred. Bloomsbury Innovations Limited of London offers a test strip, the Drink Detective, for use as a competitive immunoassay to sense flunitrazepam. This test is tedious to use, costly to produce, and the immunoassay has a propensity to denature in drinks with high alcoholic content.

Similarly, there are commercial immunoassays that detect flunitrazepam and other abused amines in urine, but these require the use of expensive laboratory instruments as well as highly trained personal to run the tests. For instance, gas chromatography-mass spectrometry (GC-MS) can detect their presence in blood and urine. Characterization methods of these compounds in urine, blood, serum, and hair samples include ion trap mobility spectrometry, fluorescence detection after solid-phase extraction, HPLC tandem mass spectrometry, electrokinetic chromatography, high performance thin-layer chromatography, and immunoassays. Rapid screening reagents in conjunction with thin-layer chromatography include citric acid/acetic anhydride or the Dragendorff reagent.

Unlike the methods described, the color sensors may offer a simple, sensitive, and selective alternative to the costly immunoassays. Milan Stojanovic from Columbia University Medical Center designed aptamer MNS-4.1 containing three stems, S₁-S₂-S₃, complexed with diethylthiotricarbocyanine dye 2 (Scheme 1) to find selective and sensitive color sensors for cocaine. Aptamers consist of complementary DNA strands that are connected by a loop, which may or may not be necessary for the binding event. However, the interactions of the complementary domains and the binding pocket can be varied through altering the length and composition of the strands. Scheme 1 shows the aptamer complexed with diethylthiotricarbocyanine dye 2, which is displaced from the binding site after addition of flunitrazepam, resulting in a color change due to precipitation of the dye. At Doane College, student researchers discovered that this method also works for detecting flunitrazepam.

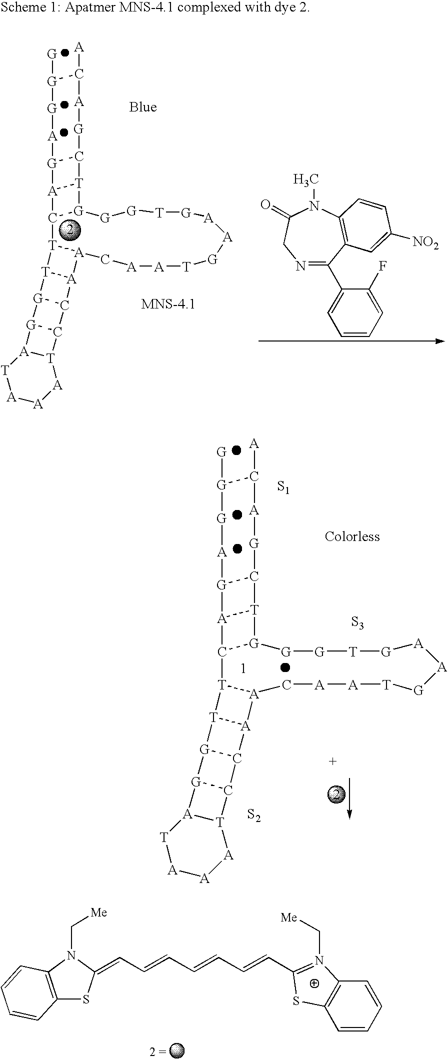

After addition of flunitrazepam, the dye precipitates, resulting in a color change from blue to colorless.

### Preliminary Results:

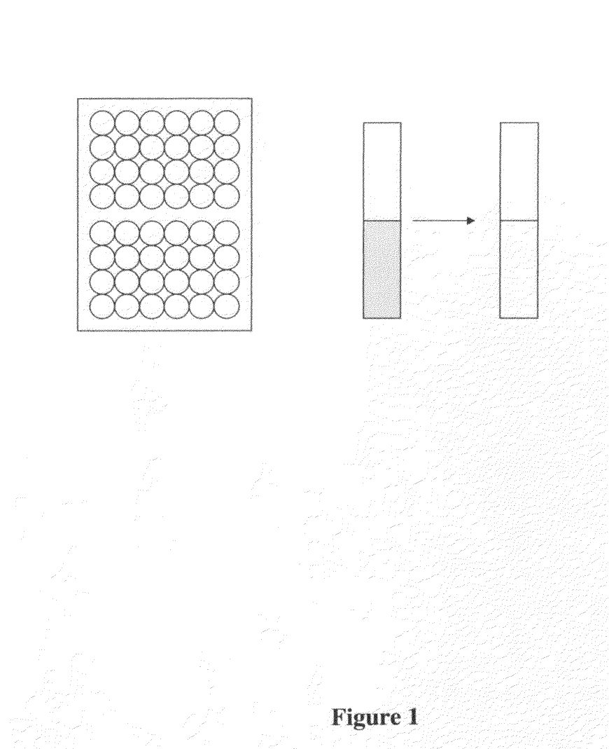

FIG. 1 shows an example of the well plates that were used with aptamer MNS-4.1 and various organic dyes whose interactions with oligonucleotides are well known. The best dyes are those that bind strongly to the aptamer with absorbance in the visible region, and exhibit large extinction coefficients. Thus, cyanine dyes are of particular interest because of their high affinity for nucleic acids, high molar absorptivity (extinction coefficient 50000 cm⁻¹M⁻¹), and large fluorescence enhancements. The wells displaying a color change were examined further by UV/Vis spectroscopy. As seen in FIG. 1, when flunitrazepam was added to the aptamer-diethylthiotricarbocyanine complex, the color changed from blue to colorless as a result of the dye displacement from the aptamer pocket.

FIG. 1: A combinatorial approach to find molecular sensors for abused narcotics. At left, well plates that were used for the aptamer-dye complexes and the narcotics. At middle, the blue aptamer-dye complex before flunitrazepam was added. At right, discoloration after flunitrazepam was added in millimolar concentrations.

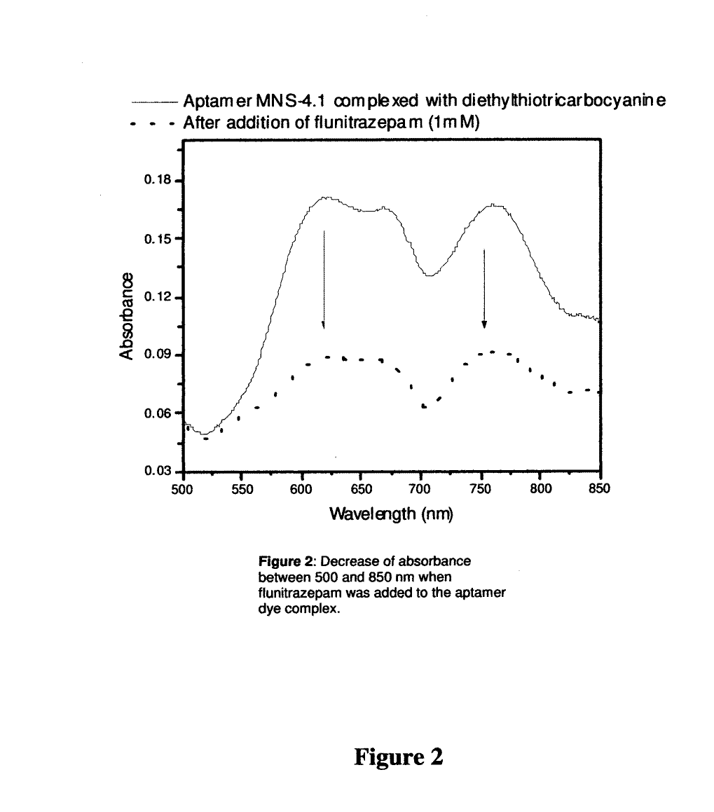

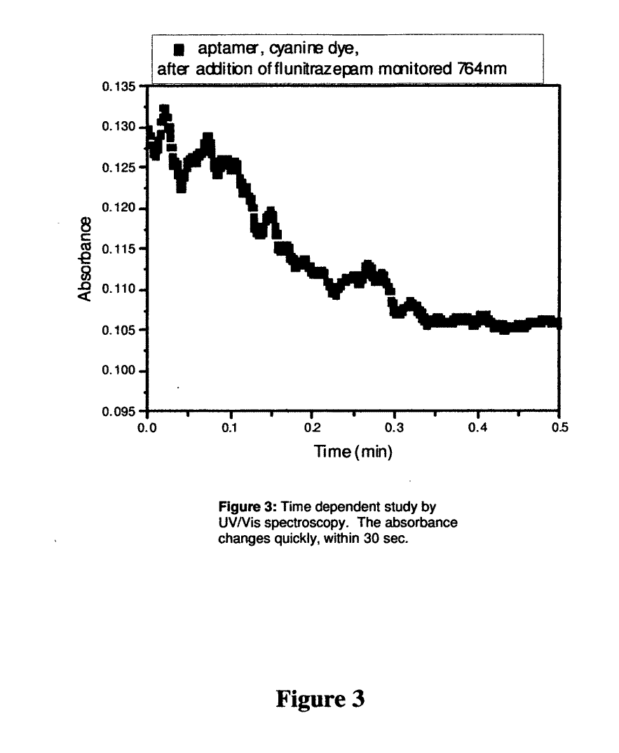

UV/Vis spectroscopy (FIG. 2) indicates that the absorbance between 500 and 850 nm decreases with the addition of flunitrazepam. Other drugs with structures similar to flunitrazepam, such as valium, resulted in very subtle absorbance changes but not a clear visible color change as with flunitrazepam. This suggests that the flunitrazepam has a higher binding affinity to the aptamer pocket, and therefore displaces the dye. Time dependence studies in FIG. 3 further supported our mechanism with color quenching within 30 sec.

Our structural model is shown in Scheme 2. First, the dissolved cyanine dye enters the binding pocket of the aptamer. As flunitrazepam is added, the dye leaves the binding pocket, leading to an increase in concentration of the dye in solution outside the aptamer. When more cyanine dye accumulates in solution, the dye begins to aggregate and falls out of solution by precipitation, resulting in a decrease of absorbance and color change. Kinetic experiments of only the cyanine dye in TRIS-HCl buffer solution showed a different outcome—a slow gradual decrease in absorbance taking place over several hours. Although these results demonstrate that an aptamer-dye complex changes color in the presence of flunitrazepam, the color change is faint and requires greater than physiological doses of flunitrazepam. It would be advantages to improve the sensitivity by making the color change more vivid and to apply the method to the detection of other abused drugs and other small molecules.

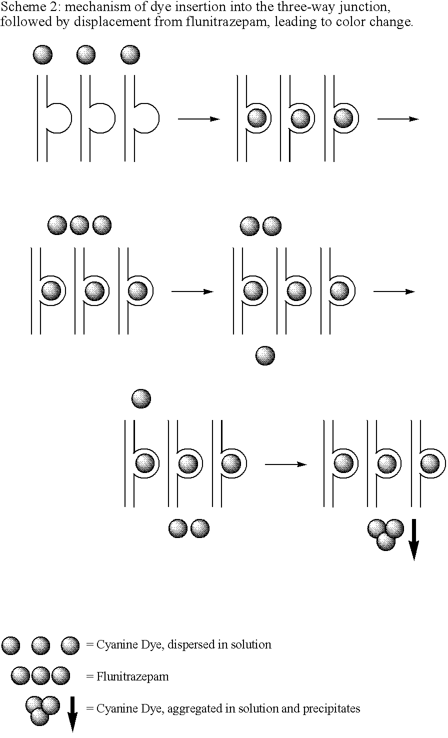

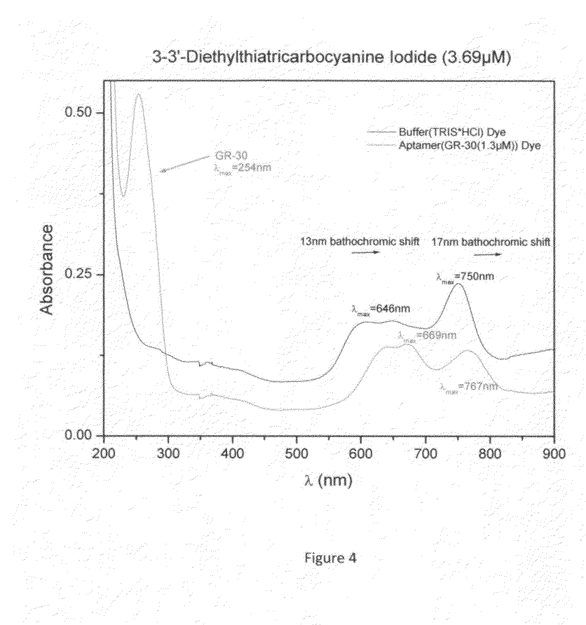

Aptamers and dyes have been tested with a micro-array reader and established a reliable spectroscopic assay for binding. One example is shown in FIG. 4, in which a bathochromatic shift of >15 nm occurs when the dye binds to aptamer GR-30² to form a complex. Similar bathochromatic shifts were found for other cyanine dyes, Methylene Blue, Reactive Green and Alizarin Yellow in GR-30.

FIG. 4: Spectroscopic binding assay of GR-30 with 3-3′-Diethylthiatricarbocyanine Iodide (3.69 μM) indicates large bathochromatic shifts upon complexation of dye to aptamer.

### Methods for Finding Drug-Binding Aptamers

### Combinatorial Methods to Find Aptamer-Dye Complexes

Acceptable dyes were determined for the aptamer collection, which were obtained by SELEX (systematic evolution of ligands by exponential enrichment) from solid-supported cocaine. Most of these aptamers consist of two complementary DNA strands that are connected by a loop. Their base sequences and the exact 3-D structures are known. The 3-way junction binding pocket allows for complexation of visible dyes. A combinatorial approach will identify suitable dyes for this purpose. Our Cary 50 UV-Vis spectrophotometer, equipped with a microplate reader system, will allow us to scan for and quantitate absorbance changes rapidly.

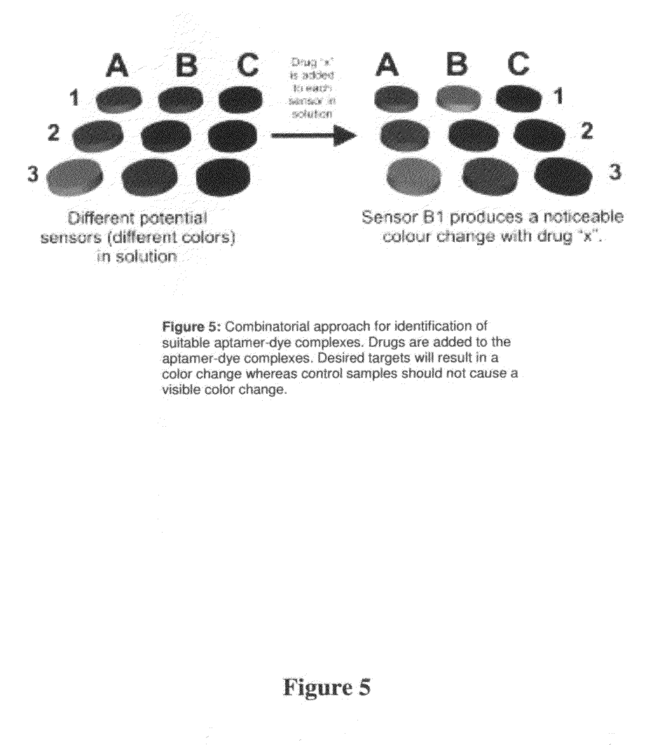

FIG. 5 shows a schematic of a small portion of a 96-well multi-cell plate, in which each row contains a different dye and each column contains a different aptamer. The recognition event of the drug to the aptamer causes a change in the microenvironment of the chromophore, which can be easily measured by absorbance changes of red and blue shifts of absorbance maxima using a microarray reader. This method aided in determining subtle color changes that are not easily visible to the naked eye because even small absorbance changes can be useful to aid in optimizing conditions for more vivid results. In this way, many aptamer-dye combinations can be screened quickly.

FIG. 5: Combinatorial approach for identification of suitable aptamer-dye complexes. Drugs are added to the aptamer-dye complexes. Desired targets will result in a color change whereas control samples should not cause a visible color change.

After the strongest aptamer-dye complex has been determined, the complexes were tested for differences in binding strengths between the dyes and the drugs to detect the optimal colorimetric sensor. If the aptamer binds more strongly to the drug than to the dye, then the dye precipitates and a decrease of absorbance occurs when the metabolite concentration is increased. These concentration-dependent changes will be measured. The controls should not cause a visible color change. If the dye does not precipitate, thus resulting in no color change, then the dye-aptamer complex is not the desired target. A well is considered a positive hit when the color disappears after the drug is added.

In order to find the strongest binding of the drug to the aptamer, the dissociation constant of the best dye-aptamer complex is measured when the drug is added, thus yielding a positive hit by the method described above. The constant is determined by UV/Vis absorbance measurements and applying the Benesi-Hildebrand equation. Once a sensitive and specific sensor has been invented, we will compare the sensor against other currently used mainstream methods such as immunoassays. All sensors are tested for temperature stability using MALDI mass spectroscopy. This technique has been applied successfully for DNA, even at very low concentrations.

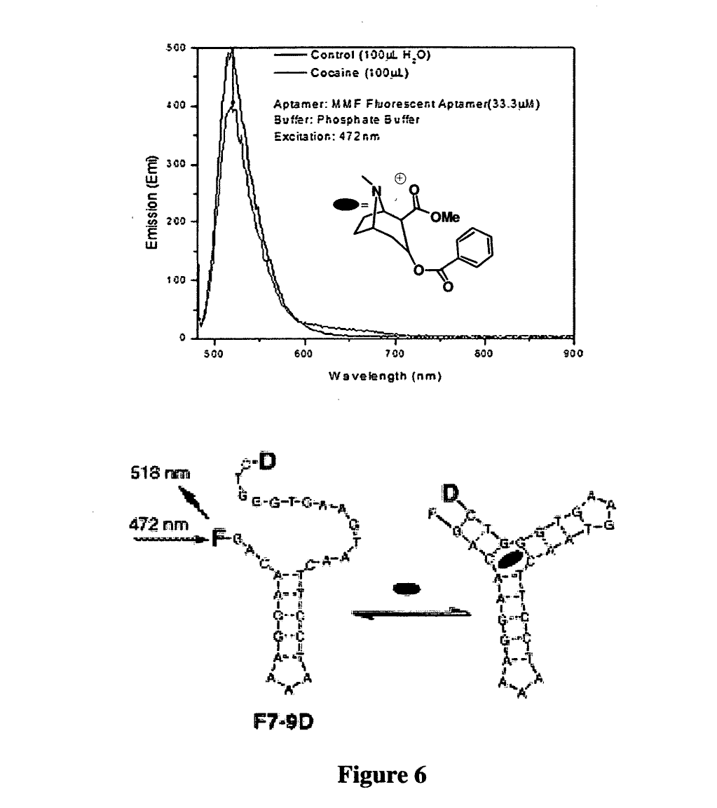

Fluorescence quenching is also used in for binding determination because some of our aptamers combine fluorescein as a strong fluorophore and dabcyl as a quencher attached to the aptamer stems. In the absence of cocaine, the two stems are open and the flourescein tag fluoresces. Upon binding of cocaine, the stems close and a binding junction forms forcing fluorophore and quencher together and the fluorescence quenches as seen in FIG. 6.

FIG. 6: Fluorescence quenching of fluorescein and dabcyl derivatized aptamer due to presence of cocaine.

Immobilization of Drugs to Resins using Flunitrazepam as an Example

This invention is dedicated to optimization of the analytical methods and to finding specific aptamers for the drugs. To do that, one can use affinity chromatography using immobilized flunitrazepam as the solid support. This will require the attachment of flunitrazepam to a polymer resin. The nitrogen in flunitrazepam could serve as a good starting point because the literature shows that it can be derivatized with molecular probes. For example, diazepine ligands have been derivatized on the nitrogen with NBD Ro-1986 and BODIPY FL Ro-1986. Thus, derivatization to a solid support seems feasible. This is a powerful alternative to using tritiated benzodiazepine analogs, which require radioactive ligand binding assays.

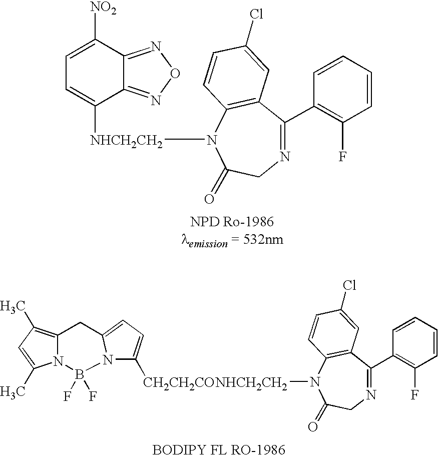

Demethylflunitrazepam 3 is commercially available as a pharmaceutical impurity from Mikromol GMBH and could be attached to any solid polystyrene support. Scheme 3 shows the alkylation of chloromethylated Merrifield polystyrene resin by 3 via an S_{N}2 mechanism. Resins of different mesh sizes and loading capacities are tested. A vast variety of commercially available condensation reagents and linkers can be tested with Merrifield resins, should the methylene linker prove to be too short for alkylation of 3. Other resins with bromides and carboxylic acids in the presence of acylation reagents is tested and evaluated for best fit. Variation of reaction conditions to accommodate solubility differences of the drugs and the resins is necessary. This includes the use of different solvents, bases, alkylating reagents, and resins with differently sized linkers to optimize these reactions. The success of these syntheses is determined by the yield, purity, and ease of the reactions. If attachment of the solid support to the nitrogen proves difficult, the nitro group of flunitrazepam can be reduced and then attached to a carboxylic acid containing resin via amide formation.

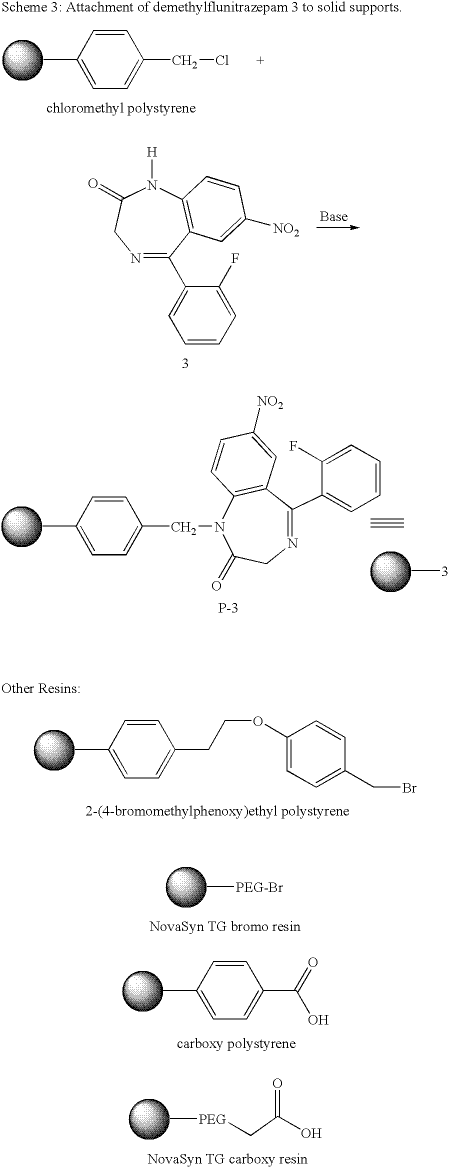

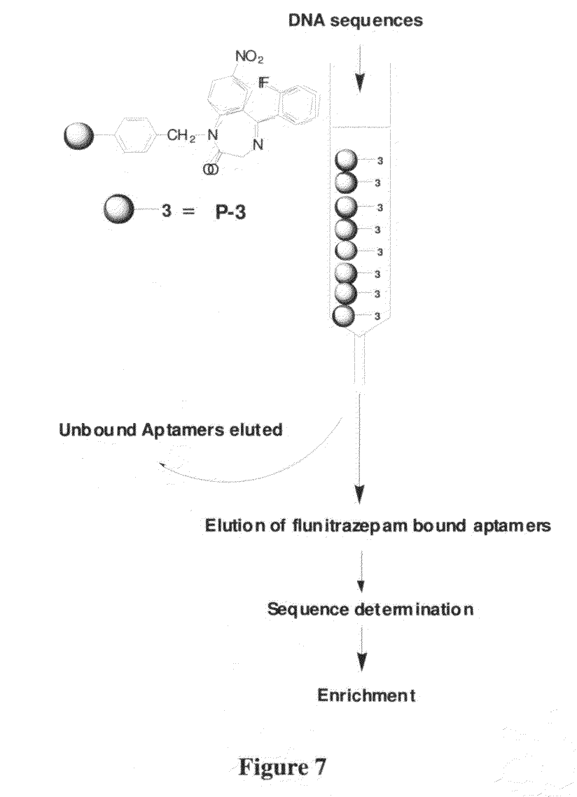

Oligonucleotide-based binders or aptamers have been used to recognize ATP, thrombin, cocaine, and cells. The in-vitro selection to isolate binding aptamers from random sequences of DNA or RNA is named SELEX or SELEXION. FIG. 7 shows the enrichment of flunitrazepam binding aptamers. The procedure consists of three steps: 1.) Packing of the affinity column with the solid-supported drug. 2.) Addition of aptamers and elution of the non-binding aptamers. 3.) Repeat the process to enrich the binding aptamers. The immobilized flunitrazepam P-3 serves as a “stamp” to imprint a selection of aptamers. P-3 is packed onto an affinity column and a pool of DNA aptamers are eluted through the column. A diverse library of custom-made DNA aptamers can be ordered through Integrated DNA Technologies, Inc. or Alpha-DNA. In order to increase the chances of finding high affinity aptamers and to maximize the enrichment process, we will use partially organized aptamers with 3-way junctions like aptamer MNS 4.1. These stem-loops are common binding motifs in previously characterized aptamers, and we will design a partially structured library to contain a centrally located stable stem-loop. Protocols for this type of methodology exist in the literature.

The DNA sequences that bind to P-3 will remain on the column while the unincorporated nucleotides are eluted. Affinity elution with free flunitrazepam releases the bound aptamers, thereby selecting the nucleotide sequences that bind to flunitrazepam, leaving behind the aptamer sequences that bind more strongly to P-3. The cycle is repeated several times for enrichment of the binding aptamers. At least three different resins is tested with different loading levels, and the binding constant of flunitrazepam to these aptamers is determined by equilibrium filtration, UV spectroscopy, or fluorescence. DNA sequence determination of the enriched aptamers will allow for the discovery of common binding motifs. A table is generated that summarizes the resins, loading capacities, and aptamer sequences. This will permit the interpretation of sequence homology and identification of optimal resins. After several binding aptamers have been determined by affinity chromatography, many commercially available visible dyes is complexed to these aptamers, including the highly fluorescent BODIPY dye series, rhodamine B, and Reactive Green 19. The strongest binding is evaluated by absorbance measurements. Addition of the drug will determine the suitable aptamer-dye complex by attenuation of absorbance or a visible discoloration. Benchmarking and validation of the aptamer-based drug sensors against current analytical tools such as UV, fluorescence, CD, etc. will determine whether this is a viable and satisfactory approach with improved sensitivity and ease of application. The same 96-well combinatorial methods as described earlier are applied.

### B. Development of Sol-Gels as Solid Supports for New Sensors

In order to examine the prospects of the use of sol-gels as a solid support for drug sensors, a protocol was developed to attach molecular sensors to this solid support. As precedence, a procedural protocol was established that allowed for the use of a stable suspension of solid colloidal silicates, such as tetramethylorthosilicate (TMOS) or tetraethylorthosilicate (TEOS), as starting materials for a solid-supported pH sensor with encapsulation of a universal indicator that is sensitive to pH changes. Similar results have been reported in the literature with Methyl Red.

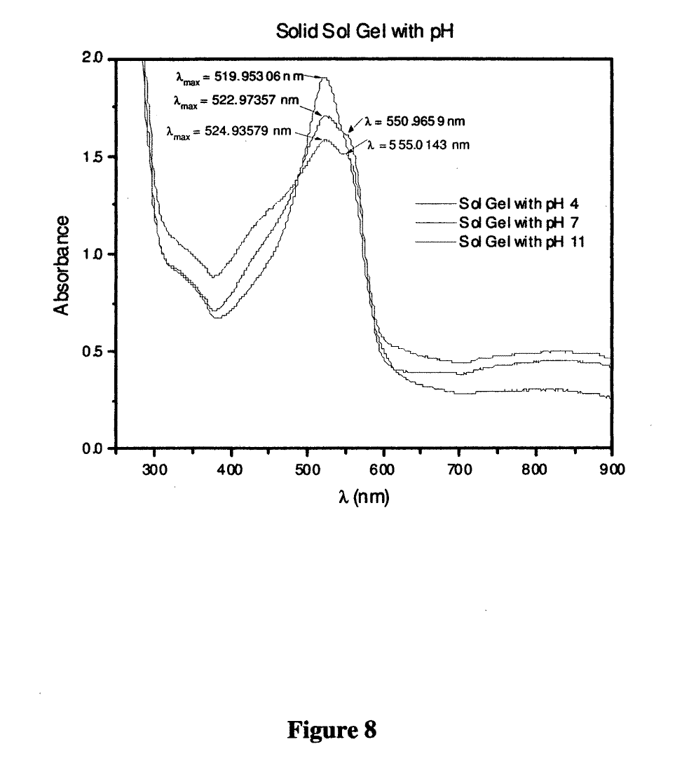

FIG. 8 demonstrates how the sol-gel pellets containing universal indicator are very sturdy, easy to handle, and change color quickly depending on the pH of the environment, e.g. red at pH=4 and purple at pH=10. These results are promising indicators that once aptamer-dye complexes are found, the sensors can be incorporated into this color-changing solid support.

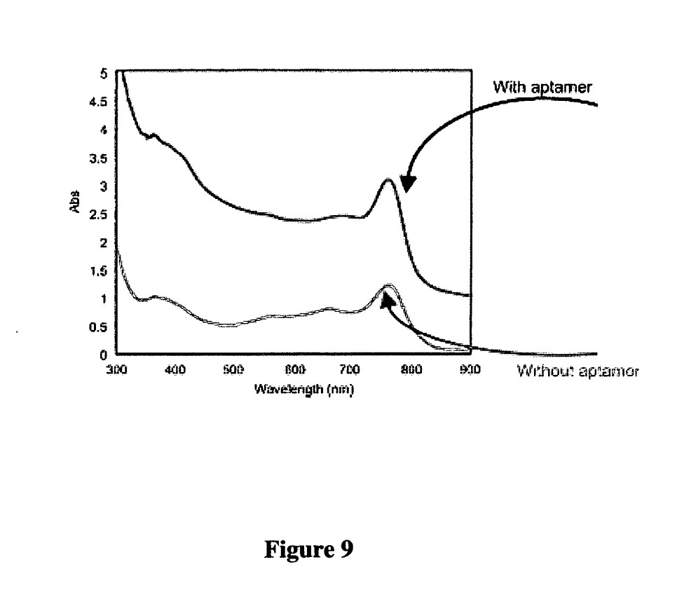

A stable suspension of solid colloidal silicates that will form a porous gel and then incorporate the aptamer-dye complexes into the sol-gels was prepared. The use of porous colloidal silicates for the synthesis of molecular imprinted polymer beads for extraction of fuel additives and caffeine has been reported in the patent literature. The starting material (TMOS or TEOS) undergoes acid-catalyzed hydrolysis with 0.04 M HCl in an ice-cooled sonic bath for about 30 min to 1 hr. The resulting “sol” is then hydrolyzed, usually with acid, to create silanol groups (Si—OH). The silanol group is produced in the presence of an acid catalyst through electrophilic substitution. After this first step, condensation of silanol groups with other silanols or non-hydrolyzed silicates occurs to produce siloxanes (Si—O—Si). Once siloxanes have formed, further condensation takes place during polycondensation (polymerization) to produce polysiloxanes that comprise the structurally rigid, optically clear, siloxane lattice of sol-gel derived glass. The resulting polymer can be linear or branched, resulting in great variability in microstructure. This liquid substance is referred to as “sol.” Following these three steps is the gelation process. The “sol” is mixed with dopant. The term “dopant” refers to the chemical species that are mixed with sol to result in sol-gel, and in this case, refers to the molecular sensors, the aptamer-dye complexes. The “sol” thus becomes immiscible with aqueous solution. The rate of gelation is known to depend on factors such as buffer type and dopant concentration. The gel represents a co-existence between a liquid phase and the solid polysiloxane lattice. FIG. 8 shows how the dopants (dye and the aptamer dye complexes) are dispersed into the sol gel. Upon evaporation of the solvent, the sol-gel condenses and incorporates the dopants into its solid lattice. Cyanine dyes often suffer from sensitivity to light and acid and photobleaching is often an undesired characteristic. However, when the cyanine dye is bound to the aptamer and then embedded into the polysiloxane lattice, less photobleaching and higher stability is attained. This is demonstrated by UV-Vis spectroscopy in which the absorbance of the cyanine dye remains high after several days (FIG. 9).

Once the color sensor is highly sensitive and specific, then a protocol is developed to attach the sensor to a solid support such as the sol-gels. The aptamer-dye complex is embedded into this gel, and the drug is added to test if the sensor will also work on this solid support. When successful, a prototype is provided to forensic scientists, who in turn will conduct field tests to evaluate feasibility and ease of application. Local law enforcement and community agencies have expressed interest in working with us.

### C. Detechip

Stoddart et al. revolutionized the field of molecular motors, shuttles, and switches built from rotaxanes, catenanes, and interlocked rings, based on molecular recognition through π-π stacking and C—H″″O bonding interactions. In fact, the molecular motion of the ATPase rotatory motor has inspired many chemists to mimic its function.⁴⁵ The area of molecular electronics aims for many desirable features, including energy efficiency, increased processing speed, and stability. Considering the extraordinary complexity and precision of natural macromolecules like proteins and DNA, contemporary research has attempted synthetically to mimic these schemes in order to achieve similar useful characteristics. Indeed, the ability to control supramolecular structures and helices could impact practical applications in the polymer, electronics, and pharmaceutical industries.

DETECHIP comprises a new sensing and recognition array utilizing aptamers and organic dyes that change color or fluorescence in the presence of illegal or dangerous substances. The sensing aptamers and dyes are incorporated into a solid (for example sol-gel matrix) in order to immobilize the optical detectors placed onto a photonic chip thus rendering them compatible with fiber optoelectronic technology. In the presence of analytes, such as drugs, the changes of optical properties are measured (a color, absorbance, or fluorescence change), and the response is detected by an optoelectronic circuit as an “off” or “on” signal, representing the binary system of “0” and “1”. The concept of organic materials in sol-gel or solid matrix coupled with optical signaling could be applied to a multitude of application, such as but not limited to viruses, bacteria, DNA, steroids, and other harmful substances. (DNA DETECHIP, Drug DETECHIP, Virus DETECHIP, Steroid, DETECHIP, Bacteria DETECHIP). DETECHIP may also be constructed without inclusion of aptamers. Combining both colorimetric and fluorimetric assays, DETECHIP® is suitable for lab and field use. More than a simple “yes or no” spot test, DETECHIP® provides twenty responses for a more complete characterization of suspect material. DETECHIP® is applicable to both plant-derived and synthetic drugs, such as cocaine or Rohypnol™, being selective and easy to use.

The DETECHIP is constructed in such a way that the optical parameters are clearly defined through a computer program. For example, a bathochromatic shift greater than 5 nm could be programmed as an “on” response, or a “1”, whereas a shift less than 5 nm gives an “off” response or “0”. A fluorescence increase or decrease greater than for example 25% leads to an “on” signal or “1”, whereas a change less than that would be programmed as a “0”. The organic molecular detectors would be very small and thus have the potential for miniaturization and fast speed. DETECHIP could be used as a stand alone and portable device that allows for cost-effective mass screening.

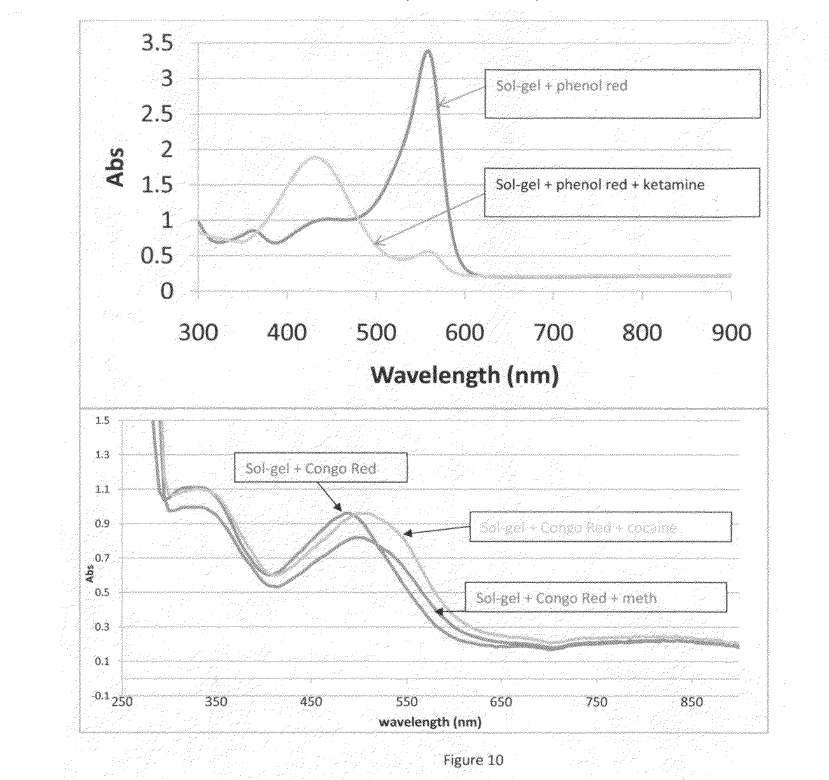

DETECHIP could have an effect on public health, more specifically, the early diagnosis and intervention of metabolic, steroid, bacterial, or viral diseases. Implementation of rapid screening methods would benefit those regions and states in which screening is not possible due to costs or complexity of the available tests. Medical intervention and treatment at an early stage of disease could save and improve the quality of lives of those affected. DETECHIP could also assume a more refined role and be integrated into measurement devices, such as mass communication networks during times of bioterrorism. DETECHIP may offer an inexpensive solution to detecting biohazardous material in the environment and dissemination of results in a fast manner. DETECHIP will contain arrays of sensing fluorescent and colored aptamers and dyes. Aptamers are not always necessary to facilitate a color change in the presence of a controlled substance. Combinatorial screening of only organic dyes in the presence and absence of drugs led to targets that changed color simply based on intermolecular interactions between dyes and drugs. For example in FIG. 10, phenol red changed color from red to orange in the presence of ketamine. Congo red also changed color in the presence of cocaine and methamphetamine (mM to uM sensitivity range). These color changes are due to acid-base interactions (phenol red is a common acid-base indicator), molecular interactions, or molecular recognition.

FIG. 10: UV-Vis spectroscopy of phenol red and congo red indicates red and blue shifts when drugs are added to the samples leading to visible color changes in the presence of ketamine, cocaine, and methamphetamine.

In addition to congo red and phenol red, we have found many other sensitive color or fluorescence indicators for abused narcotics. Table 1 summarizes the different drugs used and Table 2 summarizes the fluorescent parameters used in our assays.

TABLE 1
Listed are the scheduled drugs and common names along with common
adulterants used to dilute the quality of homemade illegal drugs.

| Common Name | Trade Name | Street Name* |
|---|---|---|
| Fentanyl Citrate | Fentora ® | Apache, China girl, China white, |
| | | Dance Fever |
| Hydrocodone | Vicodin ® | |
| Hydromorphone | Dilaudid ® | Dust, Juice, Smack, D, Footballs |
| Thebaine | | Paramorphine |
| Levo | ORLMM ® | LAAM |
| alphacetylmethadol | | |
| Ketamine | Ketalar ®, | Special K, K, Kit Kat |
| | Ketaset ® | |
| d-Methamphetamine | | Crystal Meth, Meth, Speed, Ice, |
| | | Crank |
| l-Methamphetamine | | Deoxyephedrine |
| Amphetamine | Dexedrine ®, | |
| | Adderall ® | |
| Methylphenidate | Ritalin ® | Ritalin ® |
| Cocaine | | Coke, Snow, Crack, Rock |
| Flunitrazepam | Rohypnol ® | Roofie |
| Tetrahydrocannabinol | | |
| (THC) | | |
| 1-(1- | Sernylan ® | PCP, Angel Dust |
| phenylcyclohexyl) | | |
| Piperidine | | |
| Common Adulterants | | |
| Codeine | | Pain killers, Pain Pills |
| Caffeine | | |
| Nicotine | | |
| Quinine | | |

*Information was obtained from the U.S. Drug Enforcement Administration

TABLE 2
Technical parameters used for measuring fluorescence properties
of eosin y and 8-hydroxypyrene in the presence of abused narcotics

| Dye | Eosin Y | 8-Hydroxypyrene |
|---|---|---|
| Excitation Slit Width | 3 nm | 1.5 nm |
| Emission Slit Width | 5 nm | 3 nm |
| Excitation Wavelength | 255 nm | 290 nm |
| Emission Start and | 260 nm-900 nm | 300 nm-900 nm |
| Stop Wavelength | | |

Dyes are historically among the most widely used industrial chemicals, with applications for food, cosmetics, toiletries, and textile industries, to name a few. They impart a visual stimulus to consumers, and offer an enhanced psychological impact. While this is a mature field, there are still inherent problems associated with dyes due to their chemical nature. For instance, iron oxide is the primary colorant of rouge makeup, despite the availability of many organic dyes and pigments. Many dyes are comprised of conjugated chromophores, which tend to aggregate, causing non-ideal color changes such as dullness, loss of color purity, and fluorescence quenching when incorporated into formularies. This invention uses organic dyes, many of them FDC (approved for food, drug, and cosmetic) colors. Many food dyes and D&C dyes are water soluble and are easily dissolved in aqueous buffers, alcoholic solutions, and detergents (U.S. Pat. No. 6,630,019, U.S. Pat. No. 6,143,280). This is compatible with the solubility of many small molecules such as narcotics which are often presented as salts to ensure water solubility.

DETECHIP is a new spot test device for lab and potential field use. DETECHIP is radically different from current spot tests, relying on the interactions between suspect materials and non-toxic dyes rather than functional group reactivity. DETECHIP is a mix-and-measure assay providing a stable color and fluorescent signal for the rapid detection of commonly abused plant-derived and designer drugs. Unlike other color tests which proved a single “yes or no” response, DETECHIP gives twenty simultaneous responses allowing users to quickly characterize suspect materials. DETECHIP also allows users to test controls alongside suspect materials, unlike other assays that only describe the control. Here we describe the design and preliminary characterization of DETECHIP.

### Standards and Reagents

All standards and reagents were purchased from Sigma-Aldrich (St. Louis, Mo.) unless noted.

Drug sample preparation: All scheduled drugs were purchased with DEA licensing approval. In addition to the scheduled drugs, a selection of common adulterants (including cutting agents) was tested. A complete list of all scheduled drugs and adulterants used in this study are listed in Table I. Stock solutions were prepared at micromolar to millimolar concentrations in the solvents according to Table SI. A wide variety of drugs and adulterants are water soluble, thus water, preferably de-ionized, was used as both solvent and control solution. Analytes insoluble in water, such as flunitrazepam or 1-methamphetamine, were solubilized in ethanol or methanol. In all experiments, the solvents, either water, ethanol, or methanol, served as the control solution. Based on initial experiments, approximately 1.5 mL of analyte stock solution is required per DETECHIP® testing platform.

Over-the-counter (OTC) sample preparation: All samples were purchased from the local grocery store and subjected to passive extraction in water and ethanol at room temperature. For colored tablets, the coating was removed before dissolution, when possible. For each OTC, a single tablet was placed in 10 mL of solvent. After approximately 2 hours, each tablet was crushed, mixed, and left undisturbed for up to 48 hours. Samples were then centrifuged at 6000 rpm for 5 min to settle the undissolved materials. The supernatant was used for analysis. Table SI includes a complete list of OTCs used and active ingredient information.

TABLE SI
List of over the counter samples used and the active ingredients
according to the manufacturer.

| | | per |
|---|---|---|
| | | tablet |
| OTC | active ingredient | (mg) |
| Equate ® Nighttime sleep-aid | diphenhydramine | 25 |
| Equate ® 24 hr Allergy relief D | pseudoephedrine | 240 |
| | loratadine | 10 |
| Equate ® Allergy medication | diphenhydramine | 25 |
| Equate ® Suphedrine sinus headache | acetaminophen | 325 |
| | phenylephrine HCl | 5 |
| Equate ® Ibuprofen | ibuprofen | 200 |
| Equate ® Naproxen | naproxen | 220 |
| Equate ® Complete Multivitamin | various supplements | various |
| Tylenol ® cold day | acetaminophen | 325 |
| | dextromethorphan HBr | 10 |
| | phenylephrine HCl | 5 |
| Tylenol ® cold night | acetaminophen | 325 |
| | dextromethorphan HBr | 10 |
| | phenylephrine HCl | 5 |
| | chlorpheniramine | 2 |
| Rexall ™ Natural L-glutamine | L-glutamine | 500 |
| Spring Valley glucosamine & | glucosamine | 1500 |
| chondroitin | | |
| | chondroitin | 1200 |
| Schiff ® DHEA | dehydroepiandrosterone | 25 |
| | (DHEA) | |
| Jet-Alert ™ | caffeine | 200 |
| Valu-Rite ® Enteric Coated Aspirin | aspirin | 325 |
| Dollar General ® Antacid | calcium carbonate | 500 |
| (calcium rich) | | |

Dye preparation: Dyes were dissolved in methanol to yield a 150 μM stock solution for ease of use when preparing DETECHIP® assay.

Buffer: The buffers used for DETECHIP® were both made at 400 mM and pH 7 (Buffer A and B). Buffers at a neutral pH and 400 mM were selected to avoid an acid/base induced dye color change and to ensure solutions remained within their buffering capacity even with the addition of secondary solvents. Preliminary experiments showed that dye-analyte interactions were different between the two buffers for certain analytes. In addition, using two buffers provides additional modes of analyte characterization.

### Experimental Procedure

Preliminary work: Fourteen dyes were initially tested against each drug for noticeable color or fluorescent changes. This selection was narrowed to five dyes based on the selectivity for drugs of abuse and adulterants, easy-to-see color and fluorescence changes, and easy handling and disposal. These five dyes were used in all subsequent experiments.

DETECHIP Design and Protocol: Fabrication of DETECHIP is a simple process. First, 150 μL of each dye stock solution is placed into the appropriate wells of a 96 well optical bottom plate (Thermo Fisher Scientific, Rochester, N.Y.). A single dye occupies all 12 wells of its row with sets of 4 wells (i.e. chambers) per row comprising the analysis sequence for a single analyte. Thus, for each DETECHIP, three testing platforms are generated per 96 well plate, as illustrated in FIG. 1A. Each DETECHIP platform is 5 rows by 4 columns/wells giving 20 wells (“spots”) of information per analyte. The final step in preparing the DETECHIP is passive evaporation (less than 16 hours) of the dye solvent, leaving a deposit of solid dye within each well. Prior to analysis, 150 μL aliquots of Buffer A is added to dye occupied wells in columns 1, 2, 5, 6, 9, 10 with the remaining columns (3, 4, 7, 8, 11, 12) similarly wet with Buffer B. To the control columns (every odd number), 150 μL aliquots of control solution is added (as described earlier). Once dyes are in solution, 150 μL, aliquots of analyte solution are added to the sample columns (every even number). Mixing of solutions in wells is unnecessary but can be easily accomplished during pipetting.

Analysis: Color and fluorescent changes as a result of dye-analyte interactions were noted and confirmed by spectrophotometry and tested in triplicate. Results are described in the following section. Dye-analyte reactions were analyzed using a Varian Cary 50 UV-V is Spectrophotometer (Palo Alto, Calif.) equipped with a microplate reader. A wavelength scan from 400 nm to 800 nm was used to determine λₘₐₓ values and to confirm color changes for each dye-analyte interaction in the visible range. Fluorescence changes noted using a low UV wavelength lamp (254 nm) were confirmed using a Shimadzu RF-5301 Spectrofluorophotometer (Columbia, Md.).

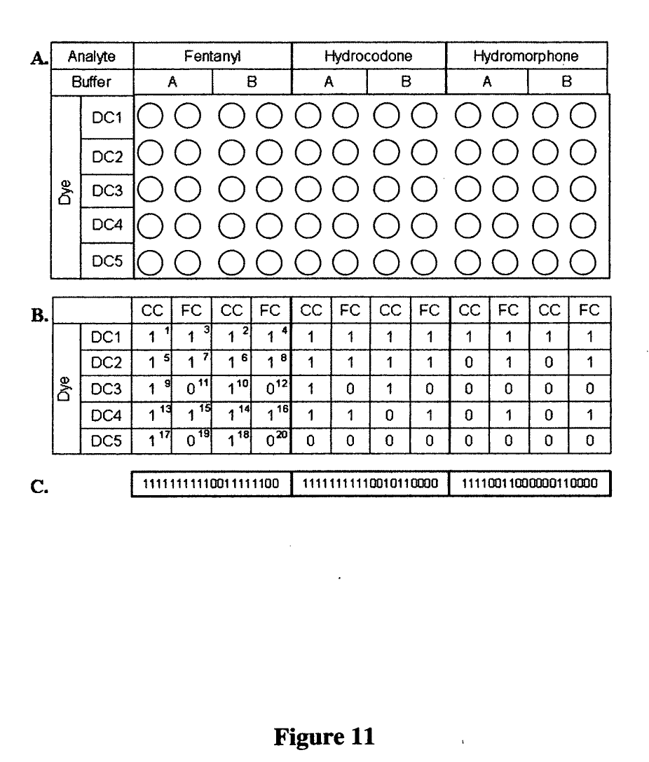

Results Table: A typical DETECHIP® ready for analysis is shown in FIG. 11A. A simple 12 column×5 row blank table using common spreadsheet software (hereafter “results table”) is shown. Color (CC) and fluorescence (FC) changes in the sample well relative to the control well are also noted (FIG. 1B). A “0” indicates no change while “1” denotes a change in the sample versus the control. The corresponding results table for the DETECHIP® in FIG. 11A is shown in FIG. 11B.

Construction of the Codes: Once the twenty simultaneous, visual responses are converted to either a “0” or “1” as in FIG. 11B, a twenty digit binary code is generated for each analyte. Beginning with row DC1, the “0” or “1” for the color change in Buffer A starts the binary code, followed by the color change for Buffer B. The third digit of the binary code is the fluorescence value (“0” or “1”) for Buffer A, row DC1, with the fourth digit the fluorescence value for Buffer B. The binary code's next four digits are sequenced in the same fashion using values for row DC2, followed by rows DC3, DC4, and DC5. A twenty digit binary code will result (FIG. 11C), which can be compared to codes available from the manufactures of DETECHIP® (NOVEL Chemical Solutions) or generated in-house using standards. Table SII shows the codes for all of the illicit drugs, while Table SIII shows the codes for the OTCs and cutting agents tested with this assay.

FIG. 11. A, Actual DETECHIP® assay using both Buffers A and B and the five dyes (DC1-DC5). Shown are the results with fentanyl, hydrocodone, and hydromorphone. Control samples are in even numbered wells and test analytes are in odd numbered wells. B, A representative of how the code for each analyte is constructed based on color (CC) and fluorescence (FC) changes seen in A. The small numbers in the upper-right corner of each block represents the order in which the code is read. C, The actual DETECHIP® codes for fentanyl, hydrocodone, and hydromorophone.

TABLE SII
List of illicit drugs, cutting agents, and their respective binary codes.

| Analyte | Solvent | Binary Code |
|---|---|---|
| Fentanyl citrate | Water | 11111111110011111100 |
| Hydrocodone | Water | 11111111110010110000 |
| Hydromorphone | Water | 11110011000000110000 |
| Thebaine | Ethanol | 00111111000000110000 |
| Levo | Water | 11000111010011010100 |
| alphacetylmethadol | | |
| Ketmaine | Water | 00110011000001110000 |
| d-Methamphetamine | Water | 00110011000001110000 |
| 1-Methamphetamine | Ethanol | 00111100000000110000 |
| Amphetamine | Water | 11111011000001111100 |
| Methylphenidate | Water | 00000000010001110000 |
| Cocaine | Water | 11111111110000111100 |
| Flunitrazepam | Ethanol | 00110011000000110000 |
| Tetrahydrocannabinol | Methanol | 00000011000000000000 |
| 1-(1- | Water | 00111111010000110000 |
| Phenylcyclohexyl) | | |
| piperidine | | |
| Codeine | Methanol | 00110011000000110000 |
| Caffeine | Water | 11111111110000111100 |
| Nicotine | Water | 00110011000000110000 |
| Quinine | Ethanol | 00110011000000110000 |

DETECHIP analysis is simple; a visual check for a color change in sample versus control wells, followed by monitoring fluorescence changes using a hand-held, low wavelength UV lamp.

Among several organic dyes that we have found to change color or fluorescence, an example of four colorimetric dyes that change color in the presence of drugs listed are:
1. Sunset yellow FCF (FD & C Yellow No. 6) (23.6 uM) detects amphetamine and cocaine
2. Allura red AC (FDC Red No. 40) (33.6 uM) detects methamphetamine, amphetamine, cocaine, and ketamine
3. Eosin Y (D&C Red No. 22) (16.75 uM) detects methamphetamine, amphetamine, cocaine, ketamine, and flunitrazepam
4. 8-hydroxypyrene-1,3,6-trisulfonic acid trisodium salt (D& C Green No. 8) (24.6 uM) detects cocaine and flunitrazepam

Two dyes that change fluoresence in the presence of the drugs listed are:
1. Eosin Y (D&C Red No. 22) (16.75 uM) detects methamphetamine, amphetamine, cocaine, ketamine, and flunitrazepam
2. 8-hydroxypyrene-1,3,6-trisulfonic acid trisodium salt (D& C Green No. 8) (24.6 uM) detects cocaine and flunitrazepam

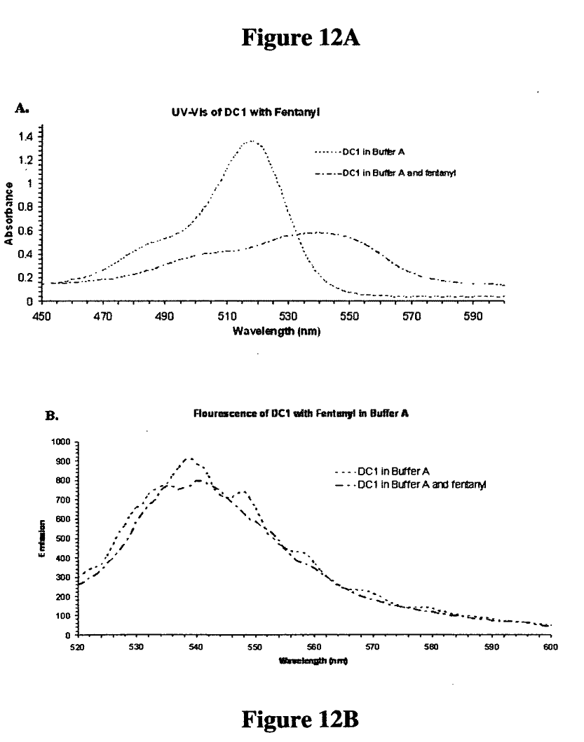

Confirmation by spectrophotometric analysis: After the addition of analytes, UV-V is and fluorescence data were collected. FIG. 12A shows an example of a UV-Vis spectrum of fentanyl in Buffer A with the dye, DC1. Samples were scanned from 800 nm to 400 nm for confirmation of either a wavelength shift or absorbance change in the presence of the test analyte. In all cases, when a color change was noted, the UV-Vis data showed λₘₐₓ shifts or decreases in absorbance similar to the visual color change shown in FIG. 12A (the addition of fentanyl caused a 23 nm shift). Additionally, when fentanyl was added to DC2, a color change occurred from neon green to very faint green accompanied by a shift from 456 nm to 433 nm and a significant decrease in absorbance; DC3, a 17 nm shift and a color change from light pink to bright pink; DC4 a 20 nm shift and a color change to bright pink; and DC5, a shift from 498 nm to 502 nm and a significant decrease in absorbance resulted in a color change from red to nearly colorless (data not shown).

For each dye sample, the λₘₐₓ was determined and used to measure fluorescent changes on the spectrofluorophotometer (FIG. 12B). In many cases, the addition of the analyte would quench the fluorescence signal as seen with the UV lamp and confirmed by fluorescence measurements. As shown in FIG. 12B, quenching was measured by fluorescence and confirmed by eye (data not shown). The other fluorescent sensors (DC2 and DC4) showed similar fluorescent quenching profiles. Of all the drugs, adulterants, and OTCs tested, only aspirin is fluorescent under experimental conditions. This is due to the conversion of acetylsalicylic acid (aspirin) to salicylic ion in aqueous solutions with pH>5 (16). Salicylic ion is easily excited using a low UV wavelength lamp, as its excitation wavelength is approximately 310 nm with emission around 400 nm.

FIG. 12. A, An example of the spectrophotmetric changes that are accompanied by a color change when fentanyl was added to DC1 in Buffer A, which led to a visible color change from peach to bright pink accompanied by a bathochromatic shift from λₘₐₓ of 517.9 nm to 539.9 nm. B, A representative example of fluorescence quenching (approximately 20%) at 538 nm when fentanyl was added to the DC1 in Buffer A.

OTC and adulterant analysis: In addition to studying commonly abused narcotics, several OTC drugs and supplements, as well as common cutting agents (i.e. quinine and codeine) were subjected to DETECHIP® analysis (results shown in Table SIII). The reasons for this were fourfold: (1) select OTC active ingredients are precursors for scheduled drugs, (2) a variety of OTCs are used as cutting or bulking agents, (3) suspect tablets may simply be OTCs for personal use or used to “dupe” a buyer, and (4) the specificity of DETECHIP® for OTCs and cutting agents versus drugs of abuse can be studied.

Specificity: DETECHIP® produces remarkable selectivity for a color test. Only two scheduled drugs had identical codes: ketamine and d-methamphetamine (Table II). This suggests changes in color and fluorescence are based on intermolecular interactions between dyes and drugs, rather than chemical reactions which are functional group specific. In all the other cases, the identical codes were matched between scheduled drugs and OTC samples or adulterants and not between scheduled drugs. It is worthy to note that although ketamine and d-methamphetamine did have identical codes, the code for 1-methamphetamine matched neither its enantiomer nor ketamine. It is very uncommon for a colorimetric drug detection system to differentiate between small molecule enantiomers. Flunitrazepam had the most matches with OTCs and cutting agents in comparison to the other drugs tested. Such identical codes suggest it may be necessary to increase the number of dyes to aid in specificity. Despite the analytes that did produce similar codes, DETECHIP® was able to uniquely identify nine illicit drugs from eleven OTCs or cutting agents. DETECHIP® design modification is currently underway to boost specificity, with the aim of providing no occurrence of false positive or false negatives for drugs of abuse, adulterants, and OTCs. This preliminary work does illustrate that through the proper selection of dyes and test conditions, a reliable assay for drugs of abuse using easy-to-handle reagents can be fabricated.

Portability: DETECHIP® has excellent potential for use in the field. The dyes are immobilized, being “inactive” until use (as described in DETECHIP® Design and Protocol). All reagents are fairly innocuous and readily available in convenient storage bottles with droppers for easy use. Solutions of suspect material can be made using sterile, rugged, and disposable supplies available form a number of chemical supply companies.

TABLE SIII
Binary codes for over the counter samples in water and ethanol.

| OTC | Water | Ethanol |
|---|---|---|
| Equate ® Nighttime sleep-aid | 11010000110011110000 | 00000000000000000000 |
| Equate ® Allergy relief D | 00000000000000000000 | 00110011000000110000 |
| Equate ® Allergy medication | 11010000110011110000 | 00000000000000000000 |
| Equate ® Suphedrine sinus headache | 11111111010011111100 | 11110000000000110000 |
| Equate ® Ibruprofen | 00000000000000000000 | 00111111000000000000 |
| Equate ® Naproxen | 11111111000000100000 | 11111111000000110000 |
| Valu-Rite ® Enteric Coated Aspirin* | 00110011001100110011 | 11111111111111111111 |
| Equate ® Complete Multivitamin | 11111111110011111100 | 11111111110011111100 |
| Tylenol ® cold day | 11110011110011110000 | 11110011000000110000 |
| Tylenol ® cold night | 11110011110011110000 | 11110011110000110000 |
| Rexall ™ Natural L-glutamine | 11111111110011110000 | 00000011000000000000 |
| Spring Valley glucosamine & | 11111111000000110000 | 00000000000000000000 |
| chondroitin | | |
| Schiff ® DHEA | 00000000000000000000 | 00000000000000000000 |
| Jet-Alert ™ | 11110011110011111100 | 11111111110011111100 |
| Dollar General ® Antacid (calcium | 00000000000000000000 | 00000001000000000000 |
| rich) | | |

*Aspirin under experimental conditions is fluorescent. The addition of aspirin automatically produces a fluorescent change. No other analyte tested had similar properties.

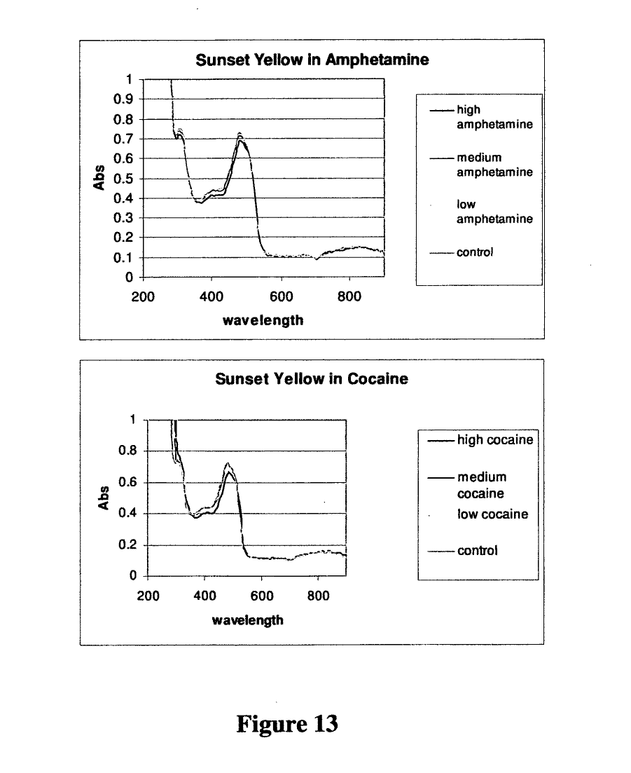

FIG. 13: UV-Vis of Sunset yellow in amphetamine and cocaine demonstrating a small shift in ₘₐₓ

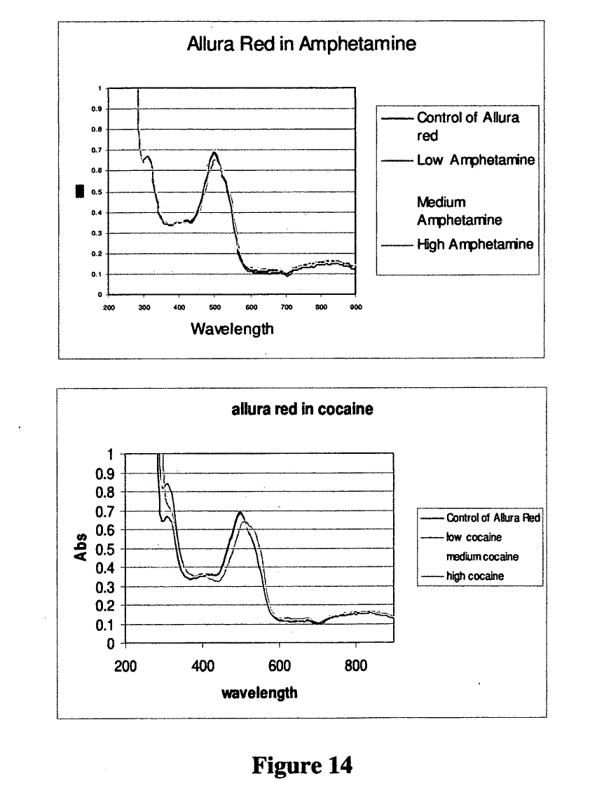

FIG. 14: UV-Vis of Allura red in methamphetamine, cocaine, amphetamine and ketamine demonstrating a small shift in ₘₐₓ

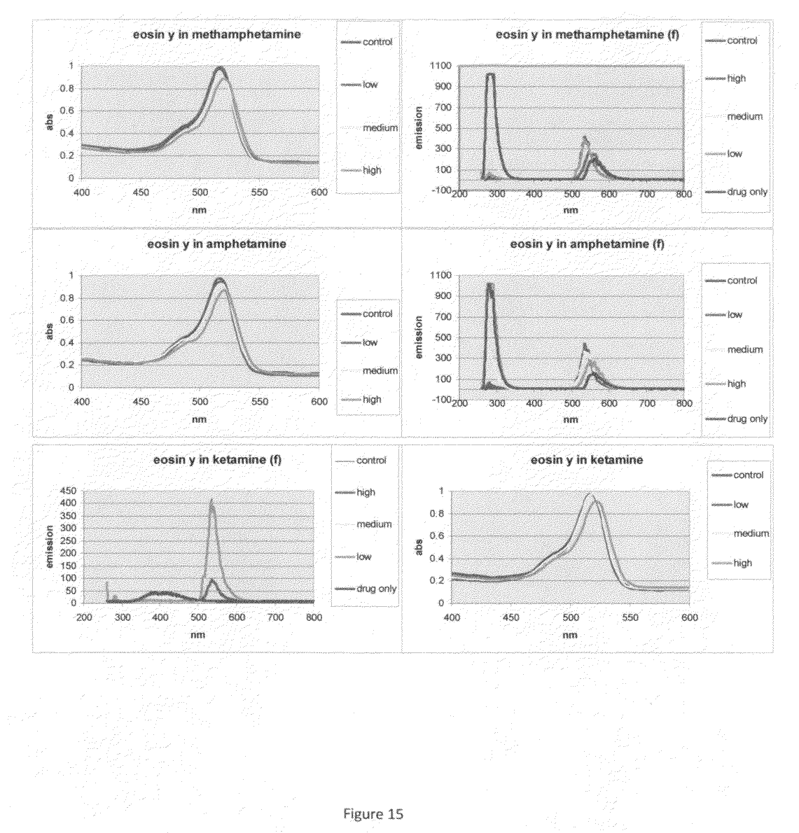

FIG. 15: UV-Vis (left) and fluorescence (right) of eosin y in the presence of methamphetamine, amphetamine, and ketamine demonstrating a bathochromatic shift and fluorescence quenching

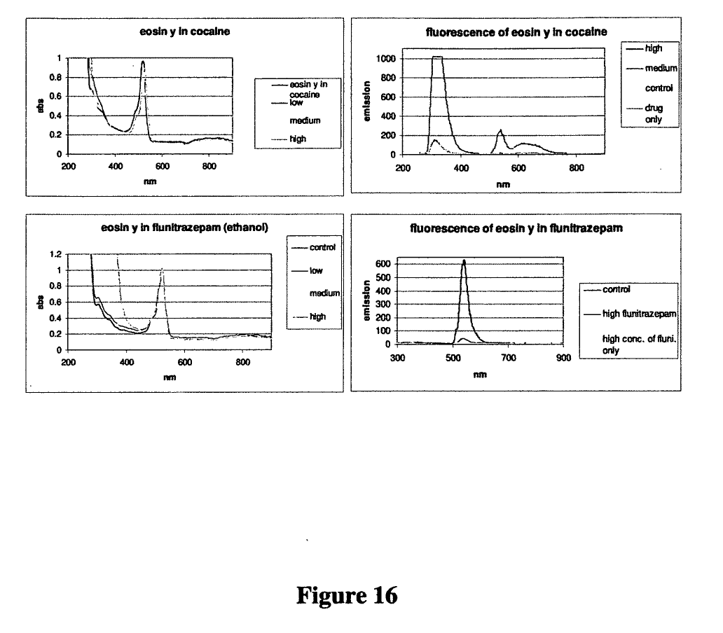

FIG. 16: UV-Vis (left) and fluorescence (right) of eosin y in the presence of methamphetamine in cocaine, and flunitrazepam demonstrating a bathochromatic shift and fluorescence quenching

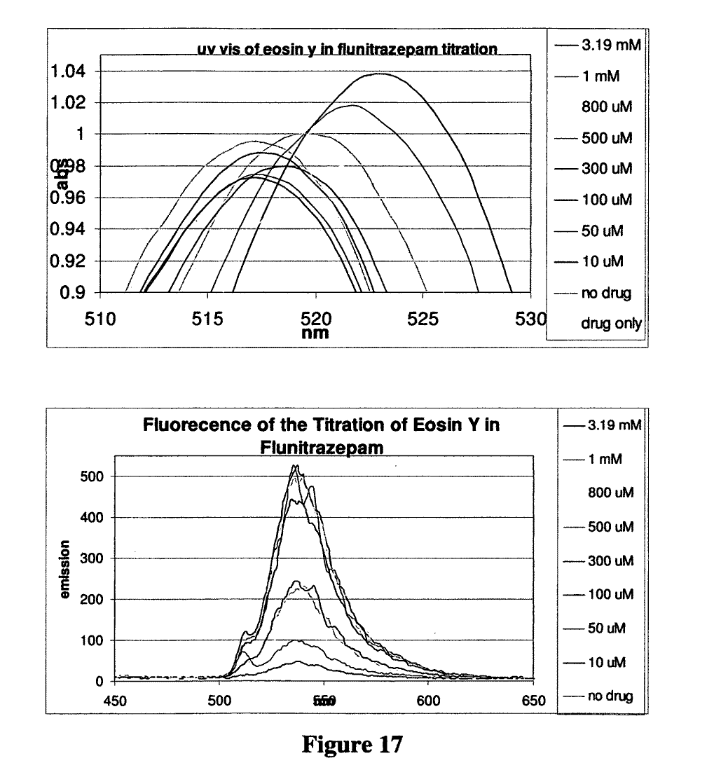

FIG. 17: UV-Vis (left) titration of flunitrazepam in eosin y and fluorescence (right) titration of flunitrazepam in eosin y demonstrating a bathochromatic shift and fluorescence quenching.

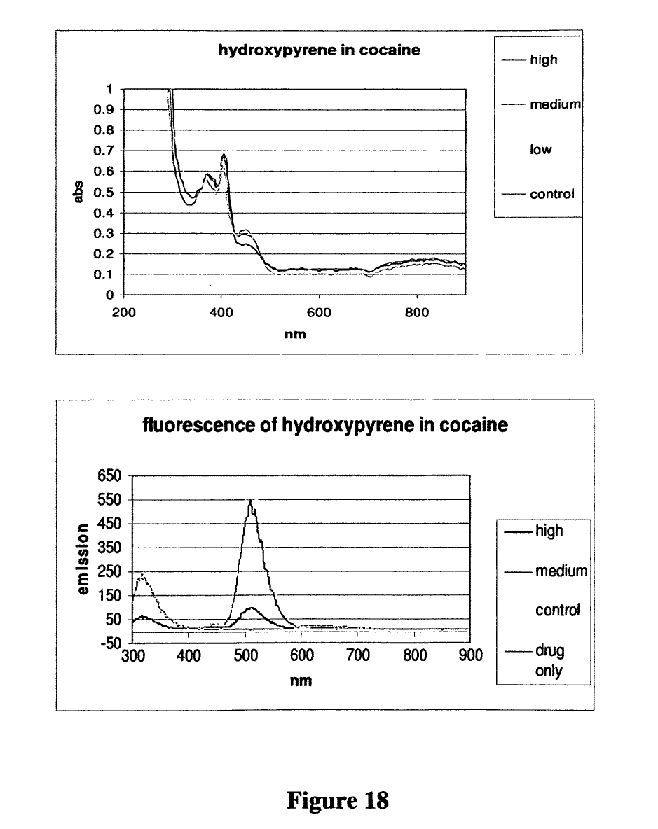

FIG. 18: UV-Vis (left) titration of cocaine in 8-hydroxypyrene-1,3,6-trisulfonic acid trisodium salt and fluorescence (right) titration of cocaine in 8-hydroxypyrene-1,3,6-trisulfonic acid trisodium salt demonstrating a bathochromatic shift and fluorescence quenching.

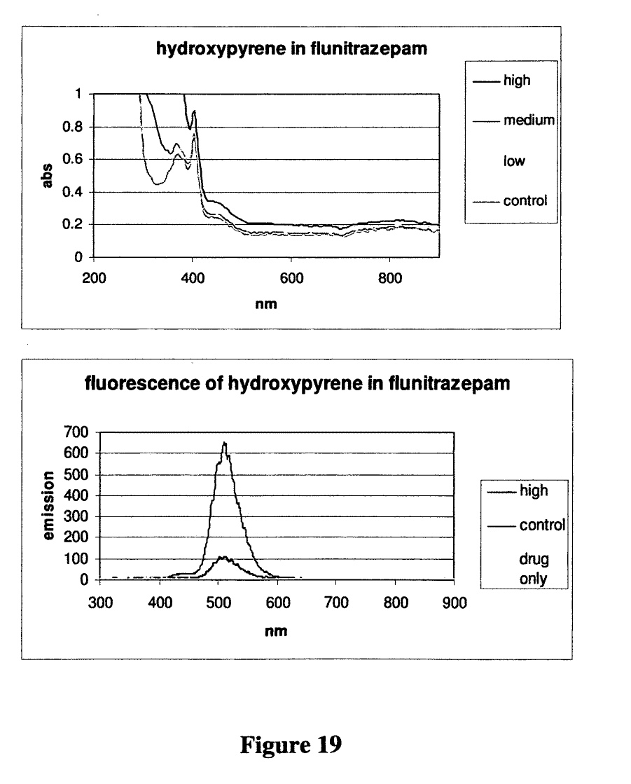

FIG. 19: UV-Vis (left) titration of flunitrazepam in 8-hydroxypyrene-1,3,6-trisulfonic acid trisodium salt and fluorescence (right) titration of flunitrazepam in 8-hydroxypyrene-1,3,6-trisulfonic acid trisodium salt demonstrating a bathochromatic shift and fluorescence quenching.

A proof of principle of DETECHIP is demonstrated in Table 3. Several drugs were exposed to the colorimetric and fluorescent sensors that we developed. In addition, we added reagents that were already known from the National Institute of Justice, such as the Marquis reagent, cobalt thiocyanate, the Simmons reagent, and the Mandelin Reagent. We added pH indicators like universal indicator, red litmus and blue litmus. All drugs tested led to a uniquely coded sequence as a result of a color or fluorescence change, clearly identifying the substance under investigation. The array can be expanded indefinitely in either direction and could test infinitely large numbers of analytes with color or fluorescent sensors.

TABLE 3
Design of a DETECHIP. Each row contains a different color or fluorescent
sensor. Each drug or substance codes for a specific binary sequence.

| | Amphetamine | | Cocaine | | Flunitrazepam | |
|---|---|---|---|---|---|---|
| | CC | FC | CC | FC | CC | FC |
| EY | 1 | 1 | 1 | 1 | 1 | 1 |
| BH | 1 | 1 | 1 | 1 | 1 | 1 |
| SY | 1 | 0 | 1 | 0 | ? | 0 |
| AR | 1 | 0 | 1 | 0 | ? | 0 |
| PB | 1 | 1 | 1 | 1 | 1 | 1 |
| EB | 1 | 0 | 1 | 0 | 1 | 0 |
| MT | 1 | 0 | 0 | 0 | 0 | ? |
| CT | 0 | 0 | 1 | 0 | 0 | ? |
| NR | 1 | 0 | 0 | 0 | 0 | 0 |
| MR | 1 | 0 | 1 | 0 | 0 | ? |
| SR | 0 | 0 | 0 | 0 | 0 | ? |
| RL | 0 | 0 | 0 | 0 | 0 | 0 |
| BL | 0 | 0 | 1 | 0 | 0 | 0 |
| UI | 1 | 0 | 1 | 0 | 0 | 0 |

| | | |
|---|---|---|
| . | . | . |
| . | . | . |
| . | . | . |
| 1111101011101000101000000010 | 1111101011100010001000001010 | 1111?0?011100000000000000000 |

| | GHB | | Ketamine | | Methamphetamine | |
|---|---|---|---|---|---|---|
| | CC | FC | CC | FC | CC | FC |
| EY | ? | ? | 1 | 1 | 1 | 1 |
| BH | ? | ? | 1 | 1 | 0 | 1 |
| SY | ? | 0 | 1 | 0 | 0 | 0 |
| AR | ? | 0 | 1 | 0 | 1 | 0 |
| PB | ? | ? | 0 | 1 | 1 | 1 |
| EB | ? | ? | 1 | 0 | 1 | 0 |
| MT | 0 | ? | 0 | ? | 1 | ? |
| CT | 0 | ? | 0 | ? | 0 | ? |
| NR | 0 | 0 | 1 | 0 | 1 | 0 |
| MR | 0 | ? | 0 | ? | 1 | ? |
| SR | 0 | ? | 0 | ? | 1 | ? |
| RL | ? | 0 | 0 | 0 | 0 | 0 |
| BL | ? | 0 | 1 | 0 | 0 | 0 |
| UI | ? | 0 | 0 | 0 | 1 | 0 |

| | | |
|---|---|---|
| . | . | . |
| . | . | . |
| . | . | . |
| ?????0?0????0?0?000?0??0?0?0 | 1111101001100?0?100?0?001000 | 1101001011101?0?101?1?000010 |

| | Tetrahydrocannabinol | | Morphine | | Methadone | | Deoxphedrine | | Hydrocodone | |
|---|---|---|---|---|---|---|---|---|---|---|
| | CC | FC | CC | FC | CC | FC | CC | FC | CC | FC |
| EY | 1 | 1 | 0 | 0 | 1 | 0 | 0 | 1 | 1 | 1 |
| BH | 0 | 0 | 1 | ? | 1 | 1 | 1 | 1 | 1 | 1 |
| SY | 0 | 0 | 0 | 0 | 1 | 0 | 0 | 0 | 0 | 0 |
| AR | 1 | 0 | 0 | 0 | 1 | 0 | 0 | 0 | 0 | 0 |
| PB | | | | | | | | | | |
| FB | | | | | | | | | | |
| MT | | | | | | | | | | |
| CT | | | | | | | | | | |
| NR | 1 | 0 | 0 | 0 | 0 | 0 | 0 | 0 | 0 | 0 |
| MR | | | | | | | | | | |
| SR | | | | | | | | | | |
| RL | | | | | | | | | | |
| BL | | | | | | | | | | |
| UI | | | | | | | | | | |

| | | | | |
|---|---|---|---|---|
| . | . | . | . | . |
| . | . | . | . | . |
| . | . | . | . | . |
| 1100001010 | 001?000000 | 1011101000 | 0111000000 | 1111000010 |

| | Hydromorphone | | Methylphenidate | | Fentanyl | | LAAM | |
|---|---|---|---|---|---|---|---|---|
| | CC | FC | CC | FC | CC | FC | CC | FC |
| EY | 1 | 1 | 1 | 0 | 1 | 1 | 1 | 0 |
| BH | 1 | 1 | 0 | ? | 1 | ? | ? | ? |
| SY | 0 | 0 | 0 | 0 | 0 | 0 | ? | ? |
| AR | 0 | 0 | 0 | 0 | 1 | 0 | 0 | 0 |
| PB | | | | | | | | |
| FB | | | | | | | | |
| MT | | | | | | | | |
| CT | | | | | | | | |
| NR | 1 | 0 | 0 | 0 | 1 | 0 | 1? | 0 |
| MR | | | | | | | | |
| SR | | | | | | | | |
| RL | | | | | | | | |
| BL | | | | | | | | |
| UI | | | | | | | | |

| | | | |
|---|---|---|---|
| . | . | . | . |
| . | . | . | . |
| . | . | . | . |
| 1111000010 | 100?000000 | 111?001010 | 10????001?0 |

?= Not yet tested
0 = No
1 = Yes
8H = 8-Hydroxypyrene 1,3,6-trisulfonic acid trisodium salt
AR = Allura Red
BL = Blue Litmus Paper
CC = Color Change
CT = Cobalt Thiocyanate
EB = Erythrosine B
EY = Eosin Y
FC = Fluorescent Change
MR = Mandeline Reagant
MT = Marquis Test
NR = Neutral Red
PB = Phloxine B
RL = Red Litmus Paper
SR = Simon's Reagent
SY = Sunset Yellow
UI = Universal pH Paper

For each DETECHIP 96-well plate, three simultaneous testing platforms can be generated to analyze up to 3 different drugs or analyte. Each DETECHIP platform is 5 rows by 4 columns, resulting in a 20 digit “code” for each analyte.

To Prepare all Three DETECHIP Testing Platforms:
1. Add 150 μL of Buffer A to wells A,B,C,D,E in columns 1,2,5,6,9,10
2. Add 150 μL of Buffer B to wells A,B,C,D,E in columns 3,4,7,8,11,12
3. Add 150 μL of control solution to wells A,B,C,D,E in columns 1,3,5,7,9,11
4. Add 150 μL of analyte #1 to wells A,B,C,D,E in columns 2,4
5. Add 150 μL of analyte #2 to wells A,B,C,D,E in columns 6,8
6. Add 150 μL of analyte #3 to wells A,B,C,D,E in columns 10,12

To read the DETECHIP Testing Platforms:
1. Compare between columns 1 and 2.
2. Looking at the first row, A. If a color change (CC) is seen between the two columns, write down a “1” in the first blank in the first column on the results table. If no color change, write down a “0”.
3. Looking at the second row, B. If a color change (CC) is seen between the two columns, write down a “1” in the second blank in the first column on the results table. If no color change, write down a “0”.
4. Looking at the third row, C. If a color change (CC) is seen between the two columns, write down a “1” in the third blank in the first column on the results table. If no color change, write down a “0”.
5. Continue this process for the remaining two rows in columns 1 and 2.
6. Repeat this process for columns 3 and 4.
7. Repeat this process for the remaining two testing platforms ([5, 6, 7, 8] and [9, 10, 11, 12]).
8. Using a low UV wavelength lamp (254 nm), compare columns 1 and 2.
9. Looking at the first row, A. If a florescent change (FC) is seen between the two columns, write down a “1” in the first blank in the second column on the results table. If no florescent change, write down a “0”.
10. Looking at the second row, B. If a florescent change (FC) is seen between the two columns, write down a “1” in the second blank in the second column on the results table. If no florescent change, write down a “0”.
11. Continue this process for the remaining rows in columns 1 and 2.
12. Repeat this process for columns 3 and 4.
13. Repeat this process for the remaining two platforms ([5, 6, 7, 8] and [9, 10, 11, 12]).

A typical code table looks as shown in Table 4:

TABLE 4
Code table for DETECHIP

| | Analyte #1 | | | | Analyte #2 | | | | Analyte #3 | | | |
|---|---|---|---|---|---|---|---|---|---|---|---|---|
| | Column | | Column | | Column | | Column | | Column | | Column | |
| | 1 & 2 | | 3 & 4 | | 5 & 6 | | 7 & 8 | | 9 & 10 | | 11 & 12 | |
| | CC | FC | CC | FC | CC | FC | CC | FC | CC | FC | CC | FC |
| A | 1 | 3 | 2 | 4 | 1 | 3 | 2 | 4 | 1 | 3 | 2 | 4 |
| B | 5 | 7 | 6 | 8 | 5 | 7 | 6 | 8 | 5 | 7 | 6 | 8 |
| C | 9 | 11 | 10 | 12 | 9 | 11 | 10 | 12 | 9 | 11 | 10 | 12 |
| D | 13 | 15 | 14 | 16 | 13 | 15 | 14 | 16 | 13 | 15 | 14 | 16 |
| E | 17 | 19 | 18 | 20 | 17 | 19 | 18 | 20 | 17 | 19 | 18 | 20 |

To Compile a Code from a Results Table:
1. Follow the numbering scheme on the results table to complete the 20 digit code as shown below in Table 5:

TABLE 5
Example on how to assemble DETECHIP code

| CC | FC | CC | FC |
|---|---|---|---|
| 1¹ | 1³ | 1² | 1⁴ |
| 1⁵ | 1⁷ | 1⁶ | 1⁸ |
| 1⁹ | 0¹¹ | 1¹⁰ | 0¹² |
| 1¹³ | 1¹⁵ | 1¹⁴ | 1¹⁶ |
| 1¹⁷ | 0¹⁹ | 1¹⁸ | 0²⁰ |

The code for this result table is 11111111110011111100

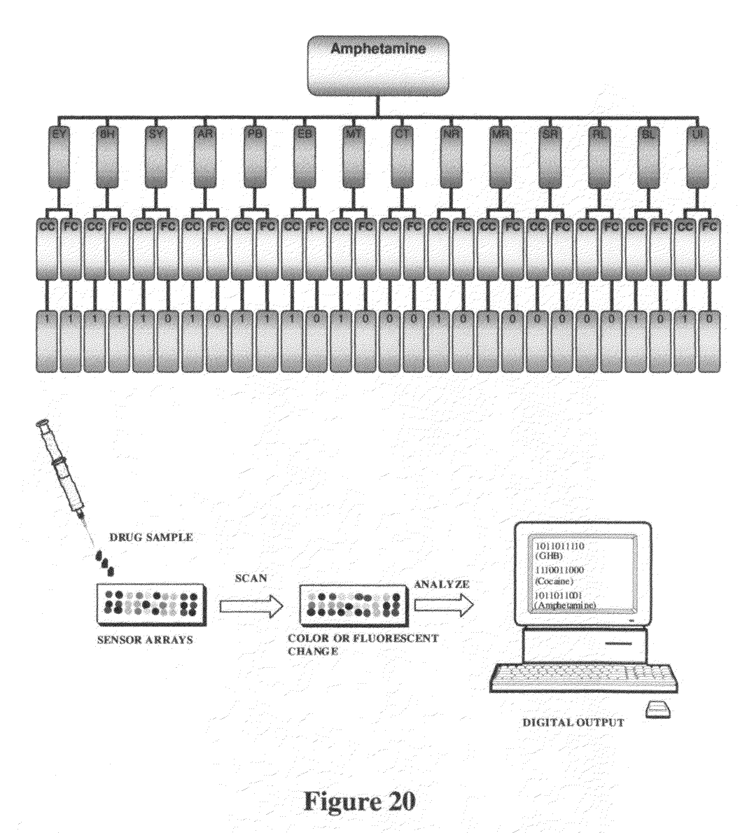

FIG. 20 demonstrates the conceptual procedures of DETECHIP technology. A chip or glass slide is coated with colorimetric and fluorescent molecular sensors. The sensors are embedded into a solid matrix such as sol-gel and then attached onto the chip, using glue or by any other practical technique. The chip is exposed to a sample of an unknown substance (for example amphetamine, cocaine, or GHB). Scanning the chip using fiber optoelectronic technology followed by computer analysis using absorbance, color, and fluorescence changes leads to a binary code that is tied to the identity of the sample.

FIG. 20: The organizational flowchart illustrates an example of how a binary code for amphetamine could be obtained using DETECHIP. Amphetamine is exposed to all the colorimetric and fluorescence tests. Color Changes (CC) and fluorescent changes (FC) are recorded with “1” or “0” meaning “yes” and “no”. The conceptual procedure for DETECHIP involves the exposure of the analytic sample to a sensor array that is scanned for color and fluorescent changes. Computer analysis determines the identity of the drug.

DETECHIP is an “all-in-one” spot test, yielding twenty simultaneous responses to generate an identification code for each analyte while allowing users to test controls alongside suspect material. Practical benefits of DETECHIP include ease-of-use, low sample volume requirements, and the use of safe and non-toxic reagents. Preliminary data reveals reasonably high specificity among scheduled drugs, OTCs, and common cutting agents. DETECHIP® has the potential to be designed in such a way that false positives and negatives are minimal. Overall, DETECHIP® is a portable, simple, and selective spot test that can be used with a variety of test analytes.

Although the description above contains much specificity, it should not be construed as limiting the scope of the invention but as merely providing illustrations of some of the presently preferred embodiments of this invention. For example, the synchronization system has been designed so that it can serve to deliver both very large content items and very small data items of any type to a plurality of users with or without continuous Internet access. While a particular implementation of the system involves using the synchronization system to transfer videos, messages, work flow diagrams, tests, and performance statistics, the synchronization system could be used independently with any one or a plurality of those applications or to manage any type of data transfer over networks. Furthermore, the invention of the team communication platform can be applied to any one or a plurality of numerous team environments where communication and team interaction are important. These environments include, but are not limited to, team sports, healthcare, education, government, and business.

Thus, the scope of the claim should be determined by the appended claims and their legal equivalents, rather than by the examples given.

What is claimed is:

1. A small molecule detection device comprising:
a chamber;
a carrier within the chamber;
a dye in combination with the carrier;
wherein the dye is capable of interacting with a small molecule target to produce a detectable change in color, fluorescence, mass uptake, refractive index, extinction coefficient, or solubility.

2. The small molecule detection device of claim 1, wherein the carrier comprises a solid selected from the group consisting of polystyrene, and a sol-gel.

3. The small molecule detection device of claim 1, wherein the carrier comprises a solid colloidal silicate.

4. The small molecule detection device of claim 3, wherein the solid colloidal silicate comprises such tetramethylorthosilicate, tetraethylorthosilicate and mixtures thereof.

5. The small molecule detection device of claim 1, wherein the small molecule target comprises a small molecule selected from the group consisting of a narcotic, prescription drug, pesticide, steroid, poison, toxin, chemical warfare agent, environmental poison, explosive, and chemical precursors and metabolites thereof.

6. The small molecule detection device of claim 1, wherein the dye comprises a fluorescent dye.

7. The small molecule detection device of claim 1, wherein the dye comprises a cyanine dyes.

8. The small molecule detection device of claim 1, further comprising an oligonucleotide-aptamers.

9. The small molecule detection device of claim 8, further comprising a second aptamer and a second dye wherein the second aptamer has a higher affinity for a second small molecule target than for the second dye.

10. The small molecule detection device of claim 9, wherein the second dye has a different absorbtion spectrum than the dye and the difference in absorbtion is detectable to the human eye.

11. A method of detecting the presence of a small molecule target in a solution, the method comprising:
providing a carrier having a dye therein;
passing a solution containing the small molecule target over the solid support;
observing or measuring a change in color, fluorescent, refractive index, extinction coefficient, mass uptake changes, or solubility; and
recording the change.

12. The method of claim 11, further comprising an aptamer and wherein the dye is complexed with the aptamer prior to passing the solution containt the small molecule target over the solid support.

13. The method of claim 12, wherein the aptamer has a greater affinity for the small molecule target than for the dye.

14. The method of claim 1, wherein the small molecule target comprises a small molecule selected from the group consisting of a narcotic, prescription drug, pesticide, steroid, poison, toxin, chemical warfare agent, environmental poison, explosive, and chemical precursors and metabolites thereof.

15. The method of claim 11, wherein the difference between an absorbtion spectrum of the solid support prior to the step of passing and an absorbtion spectrum of the solid support subsequent to the step of passing is detectable to the human eye.

16. A small molecule detection device comprising:
a solid support comprising solid colloidal silicate;
an oligonucleotide-aptamer coupled to the solid support; and
a cyanine dye, capable of complexing with the oligonucleotide-aptamer;
wherein, the oligonucleotide-aptamer has a higher affinity for a small molecule target than for the dye.

17. The small molecule detection device of claim 17, wherein the small molecule target comprises a small molecule selected from the group consisting of a narcotic, prescription drug, pesticide, steroid, poison, toxin, chemical warfare agent, environmental poison, explosive, and chemical precursors and metabolites thereof.

18. The small molecule detection device of claim 17, wherein the solid colloidal silicate comprises such tetramethylorthosilicate, tetraethylorthosilicate and mixtures thereof.

19. The small molecule detection device of claim 17, further comprising a second aptamer and a second dye wherein the second aptamer has a higher affinity for a second small molecule target than for the second dye.
